(19) United States
(12) Patent Application Publication
(10) Pub. No.: US 2014/0320409 A1
(43) Pub. Date: Oct. 30, 2014

(54) OPTICAL FINGER MOUSE EQUIPPED WITH FEEDBACK FUNCTION AND ASSOCIATED CONTROL METHOD

(71) Applicant: PixArt Imaging Inc., Hsin-Chu City (TW)

(72) Inventors: Tsung-Fa Wang, Hsin-Chu City (TW); Yung-Chang Lin, Hsin-Chu City (TW); Ching-Lin Chung, Hsin-Chu City (TW)

(73) Assignee: PixArt Imaging Inc., Hsin-Chu City (TW)

(21) Appl. No.: 14/055,852

(22) Filed: Oct. 16, 2013

(30) Foreign Application Priority Data
Apr. 30, 2013 (TW) 102115455

(51) Int. Cl. G06F 3/0354

(52) U.S. Cl. CPC G06F 3/03543
USPC 345/166

(57) ABSTRACT

An optical finger mouse includes a housing, a light source, a light guide mechanism, an image sensor, a processor and a feedback module. The housing is arranged for an object to be detected performing a motion control thereon, wherein the object to be detected slides or taps on the housing to perform the motion control. The light source is arranged for generating light. The light guide mechanism is arranged for guiding the light generated by the light source to project on the object to be detected. The image sensor captures reflected light generated from the object to be detected to generate a sensing result. The processor generates detection information according to the sensing result. The feedback module generates feedback according to the detection information.

### BACKGROUND OF THE INVENTION

1. Field of the Invention

The present disclosure relates generally to optical navigation, and more specifically, to an optical finger mouse equipped with feedback function and associated method for controlling the optical finger mouse to generate feedback to the user.

2. Description of the Prior Art

A conventional optical finger mouse can learn the directives issued by a user through detecting actions performed by a single finger of the user. Please refer to FIG. 1, which illustrates an example of operating the optical finger mousse. User's finger 10 controls a joystick 110 to perform relative sliding in respect of a housing 115, or user's finger 10 performs tapping or clicking upon the housing of the joystick 110.

The optical finger mouse 100 has a light source 120 built inside, where light emitted by the light source 120 penetrates the joystick 110 and projects upon the finger 10. The reflected light generated at this moment penetrates the joystick 110 again and is received by an image sensor located inside of the optical mouse 100, thereby generating a corresponding image sensing result. The optical finger mouse 100 has internal arithmetic circuits for analyzing the image sensing result to judge the motion of the finger 10.

Generally, the joystick 110 does not move while a finger controlling the joystick 110 moves. Hence, it is difficult for the user to notice whether the motion of the finger 10 is actually received by the optical finger mouse or not. This situation makes the user feel uncertainty in mind. In a worst case, the user may issue directives repeatedly, thus inputting erroneous user commands.

### SUMMARY OF THE INVENTION

In light of the aforesaid reasons, one of the objectives of the present invention is to provide an optical finger mouse equipped with feedback function. Through the feedback module of the optical finger mouse, the optical finger mouse can issue feedback to the user after receiving directives from the user. Another one of the objectives of the present invention is to provide a control method for controlling the optical finger mouse to generate feedback to the user.

According to an embodiment of the present invention, an optical finger mouse is disclosed. The optical finger mouse comprises: a housing for allowing an object to be detected to perform a motion control thereon, wherein the object is in a three-dimensional space above the optical finger mouse, and the object slides or taps on the housing to perform the motion control; a light source for generating light; a light guide mechanism for guiding the light to penetrate the housing; an image sensor for generating an image sensing result according to reflected light resulting from the light projected upon the object; a processor, coupled to the image sensor, for deriving a detection information by detecting the motion control of the object according to the image sensing result; and a feedback module, coupled to the processor, for generating feedback according to the detection information.

According to another embodiment of the present invention, a control method for an optical finger mouse is disclosed. The optical finger mouse comprises a housing and a feedback module, where the housing is for allowing an object to be detected to perform a motion control thereon, and the object is in a three-dimensional space above the optical finger mouse, and slides or taps on the housing to perform the motion control. The control method comprises: generating light; guiding the light to penetrate the housing; generating an image sensing result according to reflected light resulting from the light projected upon the object; deriving a detection information by detecting the motion control of the object according to the image sensing result; and generating feedback according to the detection information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional optical finger mouse.

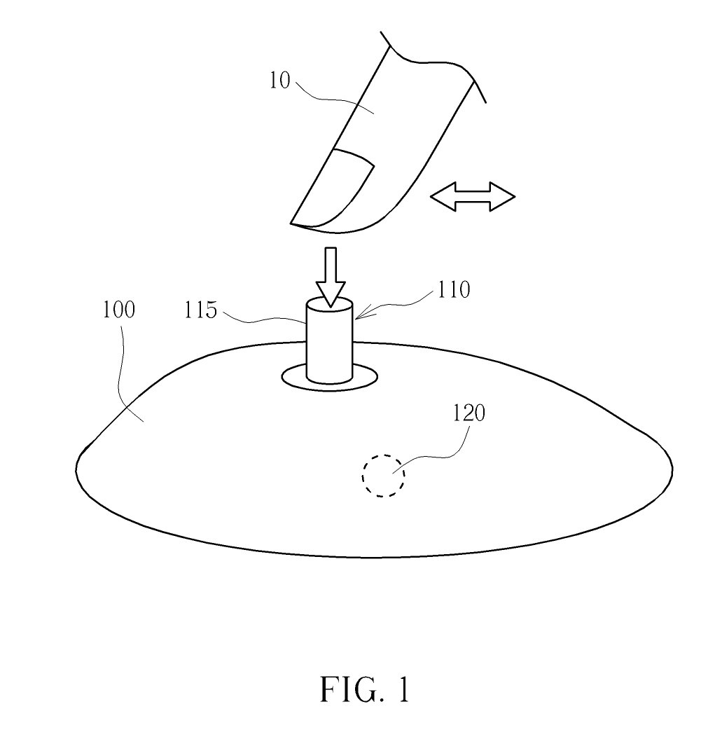

FIG. 2 is a diagram illustrating an optical finger mouse according to an embodiment of the present invention.

FIG. 3 is a diagram illustrating a feedback module according to an embodiment of the present invention.

FIG. 4 is a diagram corresponding to an embodiment of the sliding control.

FIG. 5 is a diagram corresponding to an embodiment of the tapping control.

FIG. 6 is a flowchart illustrating a control method according of an embodiment of the present invention.

### DETAILED DESCRIPTION

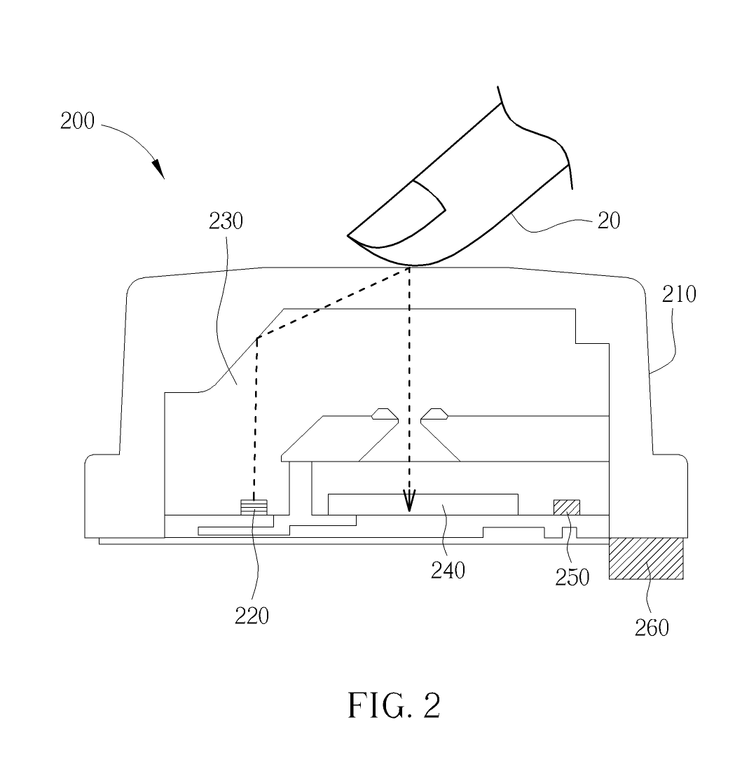

Please refer to FIG. 2, which is a diagram illustrating an optical finger mouse according to an embodiment of the present invention. As shown in FIG. 2, the optical finger mouse 200 includes: a housing 210, a light source 220, a light guide mechanism 230, an image sensor 240, a processor 250 and a feedback module 260. The housing 210 is used for allowing an object 20 to be detected to perform a motion control thereon, wherein the object 20 to be detected may be a user's finger or other object that may be employed by the user to control the optical finger mouse 200. Generally speaking, the object 20 to be detected is in a three-dimensional space L above the optical finger mouse 200. When the user wants to perform a sliding control upon the optical finger mouse 200, the user may utilize the object 20 to slide over the housing 210. The optical finger mouse 200 has arithmetic circuits located inside for detecting the sliding action performed by the object 20 and then generating corresponding sliding directives including information regarding sliding speed, direction, etc. to a system the user desires to control. Similarly, the arithmetic circuits located inside the optical finger mouse 200 is capable of detecting the tapping action performed by the object 20 and then generating corresponding tapping directives to a system the user desires to control.

The light source 220 is used for generating light, where the light could be visible or invisible light with a suitable wavelength to be capable of penetrating the housing 210. By using the light guide mechanism 230, the light is guided toward the housing 210 and penetrates the housing 210. When the object 20 is in the three-dimensional space L above the housing 210, a reflected light will be formed, and then penetrate the housing 210 to enter an inner space enclosed by the housing 210. Meanwhile, the image sensor 240 generates an image sensing result according to the received reflected light, wherein the image sensing result may be consecutive image frames. Contents of the image frames could reflect the change of the position of the object 20 made by relative sliding in respect of the housing 210, such as the position change resulting from the object 20 moving toward or moving away from the housing 210 in a horizontal direction or vertical direction. The processor 250 coupled to the image sensor 240 is dedicated to analyzing changes of the image sensing result. The processor 250 determines the motion of the object 20 according to an analyzing result to derive detection information. For instance, if the object 20 approaches the housing 210 from a distance in a direction perpendicular to the top surface of the housing 210, the processor 250 will consider the object 20 has made one tapping control. This kind of detection may be determined according to the detected size of the object 20 reflected from the image sensing result. If the object 20 approaches the housing 210 in a direction perpendicular to the top surface of the housing 210, the image sensing result will indicate a larger sized image of the object 20; otherwise, the image sensing result will indicate a smaller sized image of the object 20. Hence, the processor 250 could determine the tapping control according to changes of the object size. If the object 20 approaches the housing 210 from a distance or the object 20 moves away from the housing 210 in a direction parallel with the top surface of the housing 210, the processor 250 will consider the object 20 has made one sliding control. This kind of detection may be determined according to the detected position of the object 20 in the image sensing result. Hence, the processor 250 could determine the sliding control according to changes of the object position, so as to generate the detection information. Then, the processor 250 generates the detection information associated with the tapping or sliding control of the object 20 to the feedback module 260, and the feedback module 260 provides feedback correspondingly.

In other embodiments of the present invention, the feedback module 260 may include one or more than one of a light source module, a sound module and a vibration motor module used for providing optical feedback, sound feedback and vibration feedback respectively. The feedback occurs after the processor 250 makes a determination that the sliding or tapping control has been made by the object 20, thus notifying the user that the issued sliding or tapping control has been accepted by the optical finger mouse 200. Further details are given as below.

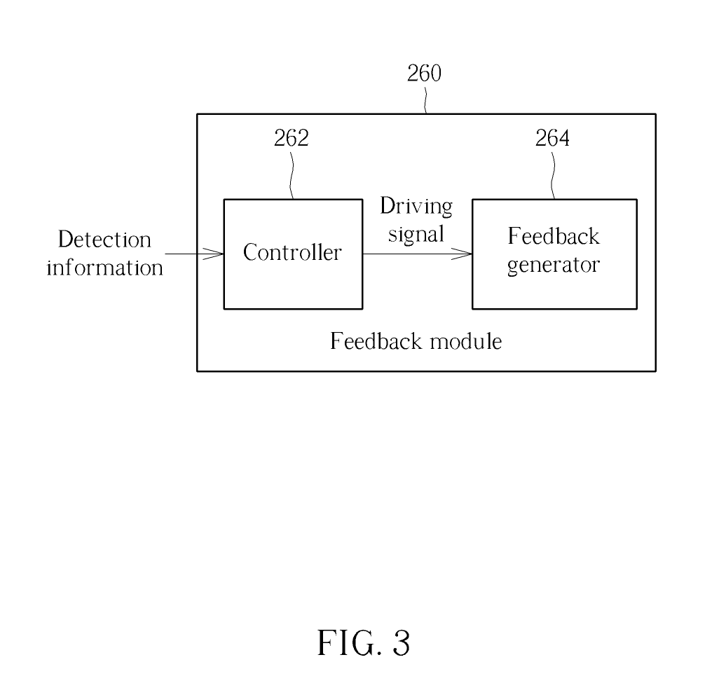

Please refer to FIG. 3, which is a diagram illustrating a feedback module according to an embodiment of the present invention. The feedback module 260 includes a controller 262 and a feedback generator 264. The controller 262 receives the detection information generated from the processor 250, and generates a corresponding driving signal to instruct the feedback generator 264 to generate the optical feedback, the sound feedback or the vibration feedback. In a case where the optical feedback is applied, the feedback generator 264 may be a light source which is capable of emitting visible light, and the feedback generator 264 may be disposed at a place where the visible light is noticeable to the user. In a case where the sound feedback is applied, the feedback generator 264 may be a speaker which is capable of playing a predetermined specific sound, and the feedback generator 264 may be disposed at a place where the sound is noticeable to the user. In a case where the vibration feedback is applied, the feedback generator 264 may be a vibration motor which is capable of delivering vibration, and the feedback generator 264 may be disposed at a place where the vibration is noticeable to the user. In an embodiment of the present invention, the feedback generator 264 may generate more than one feedback (e.g., providing optical feedback and sound feedback at the same time) to more clearly notify the user that the motion control has been accepted by the optical finger mouse 200.

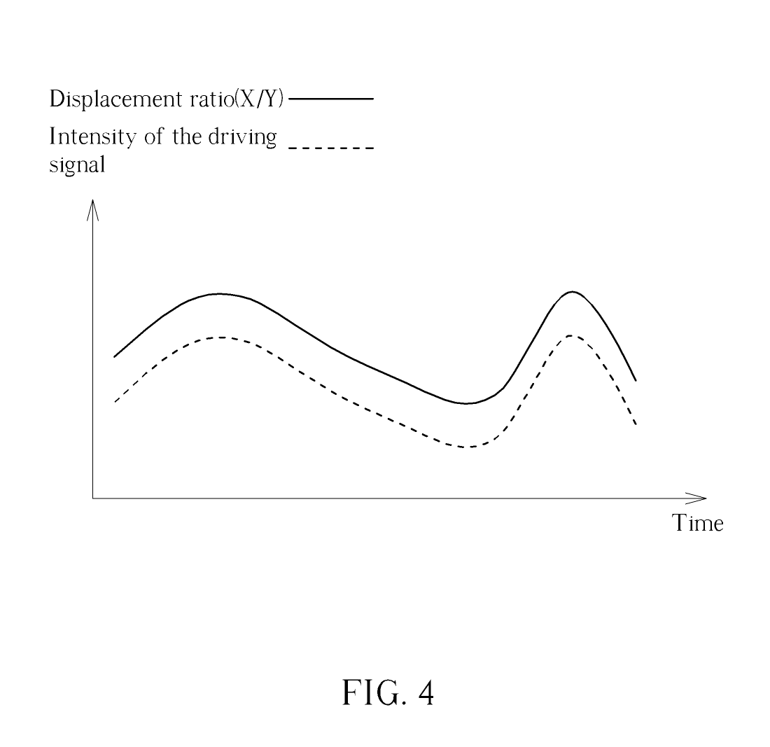

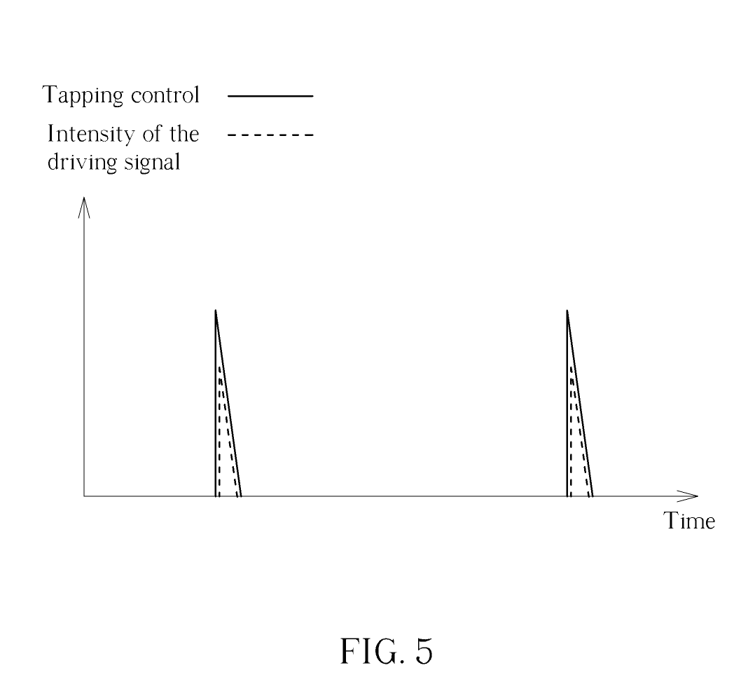

FIG. 4 and FIG. 5 explain how the feedback module 260 generates the feedback based on the detection information generated by the processor 250. Please refer to FIG. 4 first. FIG. 4 is a diagram illustrating an embodiment corresponding to the sliding control, where the solid curve represents the horizontal displacement ratio (i.e., a ratio of a direction X and a direction Y) of the object 20 detected by the processor 250 versus time, namely the speed of the object 20. The dotted curve represents the intensity of the driving signal generated by the controller 262. As can be seen in FIG. 4, if the moving velocity of the object 20 is increasing in the horizontal direction, the controller 262 will increase the intensity of the driving signal for controlling the feedback generator 264 to deliver stronger feedback. FIG. 5 is a diagram illustrating an embodiment corresponding to the tapping control, where the solid line indicates the tapping control of the object 20 detected by the processor 250. As can be seen in FIG. 5, when the processor 250 detects tapping performed by the object 20 upon the housing 210, the controller 262 will generate a transient driving signal with high intensity to control the feedback generator 264, so as to notify the user that the tapping control has been received by the optical finger mouse. In an embodiment of the present invention, the feedback intensity of the tapping control is stronger than that of the sliding control for allowing the user to distinguish between feedback effects resulting from tapping control and sliding control.

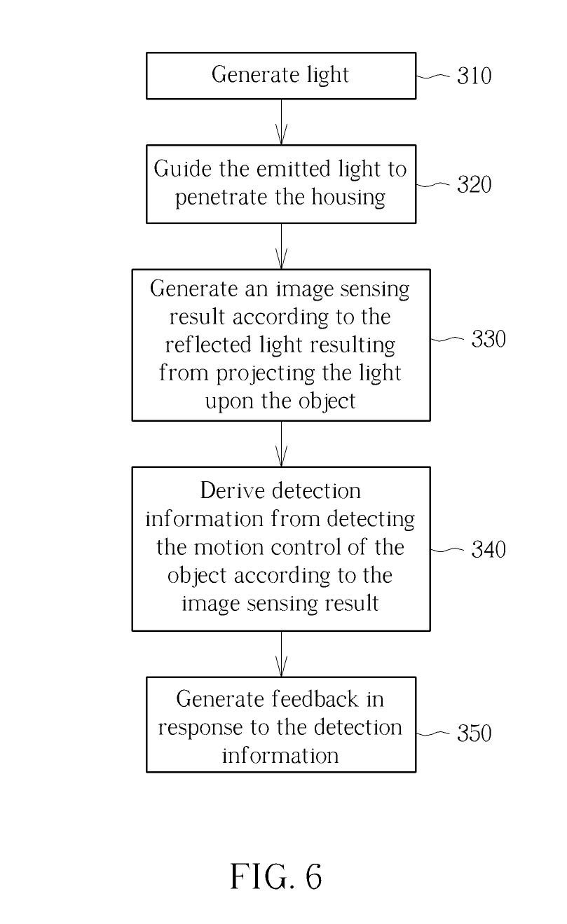

An embodiment of the present invention further provides a control method for an optical finger mouse. The method can be applied to the optical finger mouse 200 shown in FIG. 2, and include steps such as steps 310-350 shown in FIG. 6. In step 310, light is generated. In step 320, the emitted light is guided to penetrate the housing 210. Next, in step 330, an image sensing result is generated according to the reflected light resulting from projecting the light upon the object. In step 340, detection information is derived from detecting the motion control (which may be the sliding control or the tapping control) of the object 20 according to the image sensing result. Lastly, feedback is generated in response to the detection information. Since the principles, details and modifications of the control method of the present invention are given in previous paragraphs, further description is omitted here for brevity.

In the previous description, the term “an embodiment” represents that specific characteristics, architectures or features described in respect of the embodiment are included in at least one embodiment of the present invention. Moreover, the term “an embodiment” mentioned indifferent paragraphs does not represent the same embodiment. Therefore, although different structures or method are mentioned respectively in descriptions of different embodiments, but please note that the different characteristics may be implemented in a same specific embodiment through appropriate modification.

It should be noted that, in above embodiments, the motion of the finger can be detected under the condition where the region above the optical finger mouse has an area approximately equal to or even less than that of the finger.

In summary, the present invention utilizes the feedback module to enhance operating experience of the optical finger mouse. The feedback effect generated by the feedback module is sensed by the user each time a control directive is made by the user. In this way, the user can operate the optical finger mouse more easily and efficiently. Besides, the proposed optical finger mouse design with feedback function also reduces the chance of receiving erroneous user commands resulting from the user repeatedly issuing the same directive due to uncertainty.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical finger mouse, comprising:
a housing, arranged for allowing an object to be detected to perform a motion control thereon, wherein the object to be detected is in a three-dimensional space above the optical finger mouse, and slides or taps on the housing to perform the motion control;
a light source, arranged for generating light;
a light guide mechanism, arranged for guiding the light to penetrate the housing;
an image sensor, arranged for generating an image sensing result according to reflected light resulting from the light projected upon the object to be detected;
a processor, coupled to the image sensor, the processor arranged for deriving detection information by detecting the motion control of the object to be detected according to the image sensing result; and
a feedback module, coupled to the processor, the feedback module arranged for generating feedback according to the detection information.

2. The optical finger mouse of claim 1, wherein types of the motion control include a sliding control and a tapping control.

3. The optical finger mouse of claim 2, wherein the sliding control is generated by the object to be detected sliding over the housing, and the tapping control is generated by the object to be detected tapping the housing.

4. The optical finger mouse of claim 2, wherein when the object to be detected performs the tapping control, intensity of the feedback is stronger than intensity of the feedback generated at the time the object to be detected performs the sliding control.

5. The optical finger mouse of claim 2, wherein intensity of the feedback differs with a sliding speed of the sliding control performed by the object to be detected.

6. The optical finger mouse of claim 1, wherein the feedback module is a light source module, and generates optical feedback according to the detection information.

7. The optical finger mouse of claim 1, wherein the feedback module is a sound module, and generates sound feedback according to the detection information.

8. The optical finger mouse of claim 1, wherein the feedback module is a vibration motor module, and generates vibration feedback according to the detection information.

9. A control method for an optical finger mouse, wherein the optical finger mouse comprises a housing and a feedback module, the housing is arranged for allowing an object to be detected to perform a motion control thereon, and the object to be detected is in a three-dimensional space above the optical finger mouse, and slides or taps on the housing to perform the motion control, the control method comprising:
generating light;
guiding the light to penetrate the housing;
generating an image sensing result according to reflected light resulting from the light projected upon the object to be detected;
deriving detection information by detecting the motion control of the object to be detected according to the image sensing result; and
generating feedback according to the detection information.

10. The control method of claim 9, wherein types of the motion control include a sliding control and a tapping control.

11. The control method of claim 10, wherein the sliding control is generated by the object to be detected sliding over the housing, and the tapping control is generated by the object to be detected tapping the housing.

12. The control method of claim 10, wherein the step of generating the feedback according to the detection information comprises:
when the detection information indicates that the object to be detected performs the tapping control, generating the feedback with first intensity; and
when the detection information indicates that the object to be detected performs the sliding control, generating the feedback with second intensity weaker than the first intensity.

13. The control method of claim 10, wherein the step of generating the feedback according to the detection information comprises:
when the detection information indicates that the object to be detected is performing the sliding control, determining intensity of the feedback according to a sliding speed of the sliding control performed by the object to be detected.

14. The control method of claim 9, wherein the step of generating the feedback according to the detection information comprises:
utilizing a light source module to generate optical feedback according to the detection information.

15. The control method of claim 9, wherein the step of generating the feedback according to the detection information comprises:
utilizing a sound module to generate sound feedback according to the detection information.

16. The control method of claim 9, wherein the step of generating the feedback according to the detection information comprises:
utilizing a vibration motor module to generate vibration feedback according to the detection information.
